(19) United States
(12) Patent Application Publication
(10) Pub. No.: US 2014/0043822 A1
(43) Pub. Date: Feb. 13, 2014

(54) LED BULB HAVING A UNIFORM LIGHT-DISTRIBUTION PROFILE

(71) Applicant: SWITCH BULB COMPANY, INC., San Jose, CA (US)

(72) Inventors: Matrika BHATTARAI, San Jose, CA (US); Ronan LE TOQUIN, Sunnyvale, CA (US); David HORN, Saratoga, CA (US)

(73) Assignee: Switch Bulb Company, Inc., San Jose, CA (US)

(21) Appl. No.: 13/842,855

(22) Filed: Mar. 15, 2013

Related U.S. Application Data
(63) Continuation-in-part of application No. 13/588,964, filed on Aug. 17, 2012.
(60) Provisional application No. 61/681,123, filed on Aug. 8, 2012.
(60) Provisional application No. 61/772,473, filed on Mar. 4, 2013.

(51) Int. Cl. F21V 29/00

(52) U.S. Cl. CPC F21V 29/248
USPC 362/294; 29/825

(57) ABSTRACT

An LED bulb includes a stem body, a shell, a plurality of LEDs, and a thermally conductive liquid. The shell is connected to the stem body. The plurality of LEDs is disposed within the shell. The thermally conductive liquid is held within the shell. The LEDs and the shell are configured to provide the LED bulb with a uniform light-distribution profile.

### CROSS REFERENCE TO RELATED APPLICATIONS

This application claims the benefit under 35 U.S.C. 119(e) of prior copending U.S. Provisional Patent Application No. 61/681,123, filed Aug. 8, 2012, U.S. Provisional Patent Application No. 61/772,473, filed Mar. 4, 2013, each of which is hereby incorporated by reference in the present disclosure in its entirety. This application also claims the benefit under 35 U.S.C. 120 of prior copending U.S. patent application Ser. No. 13/588,964, filed Aug. 17, 2012, which is hereby incorporated by reference in the present disclosure in its entirety.

### BACKGROUND

1. Field

The present disclosure relates generally to liquid-cooled light emitting diode (LED) bulbs and, more specifically, to an LED bulb having a uniform light-distribution profile.

2. Related Art

Traditionally, lighting has been generated using fluorescent and incandescent light bulbs. While both types of light bulbs have been reliably used, each suffers from certain drawbacks. For instance, incandescent bulbs tend to be inefficient, using only 2-3% of their power to produce light, while the remaining 97-98% of their power is lost as heat. Fluorescent bulbs, while more efficient than incandescent bulbs, do not produce the same warm light as that generated by incandescent bulbs. Additionally, there are health and environmental concerns regarding the mercury contained in fluorescent bulbs.

Thus, an alternative light source is desired. One such alternative is a bulb utilizing an LED. An LED comprises a semiconductor junction that emits light due to an electrical current flowing through the junction. Compared to a traditional incandescent bulb, an LED bulb is capable of producing more light using the same amount of power. Additionally, the operational life of an LED bulb is orders of magnitude longer than that of an incandescent bulb, for example, 10,000-100,000 hours as opposed to 1,000-2,000 hours.

It may be advantageous for an LED bulb to have a uniform light-distribution profile over a substantial portion of the bulb surface. For example, portions of the Energy Star light-distribution specification states that the light intensity emissions of a light bulb should not vary greater than 20 percent over an area from 0 degrees to 135 degrees, as measured from an axis through the center of the bulb through the apex of the bulb. One challenge to producing a bulb using LEDs is that the light distribution is not inherently uniform, as stated in relevant portions of the Energy Star specifications.

The devices and methods described herein can be used to produce an LED bulb with a light-distribution profile having improved uniformity of light distribution. In several embodiments, LED bulbs are provided that produce lighting uniformity that meets Energy Star specifications for light-distribution profile uniformity.

### SUMMARY

One exemplary embodiment includes a liquid-filled light-emitting diode (LED) bulb. The LED bulb includes a stem body and a shell connected to the stem body. A plurality of LEDs is disposed within the shell. A thermally conductive liquid is held within the shell and disposed between the plurality of LEDs and the shell. A first set of LEDs of the plurality of LEDs is positioned a first distance with respect to the center of a convex portion of the shell. A second set of LEDs of the plurality of LEDs is positioned a second distance with respect to the center of the convex portion of the shell. The shell has a convex radius for the convex portion and a concave radius for a convex portion. The LEDs and the shell are configured to provide the LED bulb with a predicted light-distribution profile that varies less than 20 percent in light intensity over 0 degrees to 135 degrees as measured from an axis from the center of the shell through an apex of the shell.

Another exemplary embodiment includes a liquid-filled light-emitting diode (LED) bulb. The LED bulb includes a stem body and a shell connected to the stem body. A plurality of LEDs is disposed within the shell. A thermally conductive liquid is held within the shell and disposed between the plurality of LEDs and the shell. The plurality of LEDs is positioned a first distance with respect to the center of a convex portion of the shell. The shell has a convex radius for the convex portion and a concave radius for a convex portion. The LEDs and the shell are configured to provide the LED bulb with a predicted light-distribution profile that varies less than 20 percent in light intensity over 0 degrees to 135 degrees as measured from an axis from the center of the shell through an apex of the shell.

Another exemplary embodiment includes a liquid-filled light-emitting diode (LED) bulb. The LED bulb includes a stem body and a shell connected to the stem body. A plurality of LEDs is disposed within the shell. A thermally conductive liquid is held within the shell and disposed between the plurality of LEDs and the shell. A first set of LEDs of the plurality of LEDs is positioned a first distance with respect to the center of a convex portion of the shell, and at a first angle with respect to a centerline of the LED bulb. A second set of LEDs of the plurality of LEDs is positioned a second distance with respect to the center of the convex portion of the shell, and at a second angle with respect to the centerline of the LED bulb. The shell has a convex radius for the convex portion and a concave radius for a convex portion. The LEDs and the shell are configured to provide the LED bulb with a predicted light-distribution profile that varies less than 20 percent in light intensity over 0 degrees to 135 degrees as measured from an axis from the center of the shell through an apex of the shell.

### DESCRIPTION OF THE FIGURES

FIG. 1 depicts an exemplary LED bulb.

FIGS. 2A-B depict an exemplary LED bulb.

FIG. 2C depicts a predicted light-distribution profile for an LED bulb.

FIG. 3A depicts an exemplary LED bulb.

FIG. 3B depicts a predicted light-distribution profile for an LED bulb.

FIG. 4A depicts an exemplary LED bulb.

FIG. 4B depicts a predicted light-distribution profile for an LED bulb.

FIG. 5A depicts an exemplary LED bulb.

FIG. 5B depicts a predicted light-distribution profile for an LED bulb.

FIGS. 6A-B depict an exemplary LED bulb.

FIG. 6C depicts a predicted light-distribution profile for an LED bulb.

FIG. 7 depicts the diffusion profile for different shell materials.

FIGS. 8A-D depict exemplary support structures and LED arrangements for an LED bulb.

FIG. 9 depicts a coordinate system that may be used to describe LED bulb geometries.

FIG. 10 depicts predicted light distribution uniformity data for LED bulbs.

FIG. 11 depicts predicted light-distribution uniformity data for LED bulbs.

FIGS. 12A-B depict predicted light-distribution uniformity data for LED bulbs.

FIG. 13 depicts predicted light-distribution uniformity data for LED bulbs.

FIGS. 14A-B depict an exemplary LED bulb.

FIG. 14C depicts a predicted light-distribution profile for an LED bulb.

FIGS. 15A depicts an exemplary LED bulb.

FIG. 15B depicts a predicted light-distribution profile for an LED bulb.

FIGS. 16A-B depict an exemplary LED bulb.

FIGS. 17A-B depict the predicted and measured light-distribution profiles for an LED bulb.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below, relating to LED bulbs. As used herein, an “LED bulb” refers to any light-generating device (e.g., a lamp) in which at least one LED is used to generate the light. Thus, as used herein, an “LED bulb” does not include a light-generating device in which a filament is used to generate the light, such as a conventional incandescent light bulb. It should be recognized that the LED bulb may have various shapes in addition to the bulb-like A-type shape of a conventional incandescent light bulb. For example, the bulb may have a tubular shape, globe shape, or the like. The LED bulb of the present disclosure may further include any type of connector; for example, a screw-in base, a dual-prong connector, a standard two- or three-prong wall outlet plug, bayonet base, Edison Screw base, single-pin base, multiple-pin base, recessed base, flanged base, grooved base, side base, or the like.

As used herein, the term “liquid” refers to a substance capable of flowing. Also, the substance used as the thermally conductive liquid is a liquid or at the liquid state within, at least, the operating ambient temperature range of the bulb. An exemplary temperature range includes temperatures between −40° C. and +45° C. Also, as used herein, “passive convective flow” refers to the circulation of a liquid without the aid of a fan or other mechanical devices driving the flow of the thermally conductive liquid.

### 1. Liquid-Filled LED Bulb

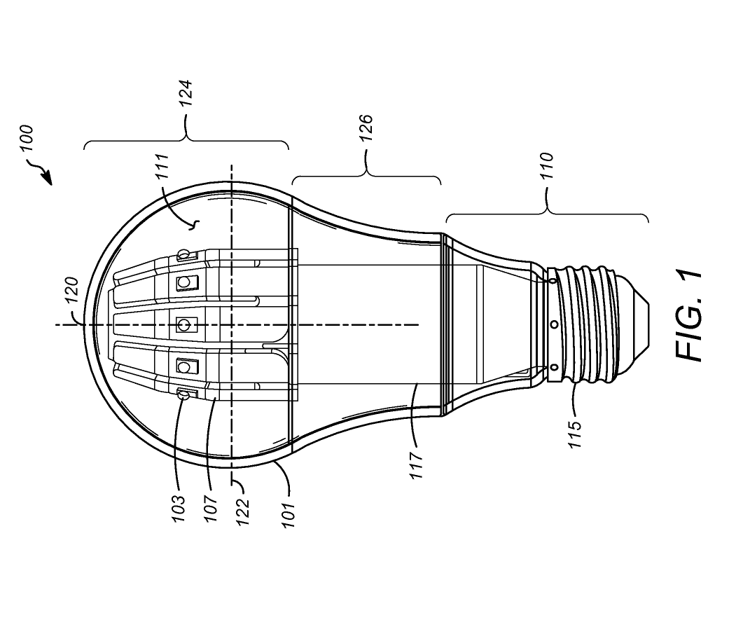

FIG. 1 depicts an exemplary liquid-filled LED bulb 100. LED bulb 100 includes a stem body 110 and a shell 101 encasing the various components of LED bulb 100. The shell 101 is attached to the stem body 110, forming an enclosed volume. An array of LEDs 103 is mounted to support structures 107 and is disposed within the enclosed volume. The enclosed volume is filled with a thermally conductive liquid 111.

For convenience, all examples provided in the present disclosure describe and show LED bulb 100 being a standard A-type form factor bulb. However, as mentioned above, it should be appreciated that the present disclosure may be applied to LED bulbs having any shape, such as a tubular bulb, globe-shaped bulb, or the like.

Shell 101 may be made from any transparent or translucent material such as plastic, glass, polycarbonate, or the like. The shell 101 may be clear or frosted to disperse light produced by the LEDs. Shell 101 has a central axis 122 and an apex 120 located at the top of the LED bulb 100 as it is drawn in FIG. 1. The apex 120 of the shell is also referred to herein as the apex of the LED bulb 100. Shell 101 also has a convex portion 124 located near the top of the LED bulb, as drawn in FIG. 1, The shell also has a concave portion 126 located near the base 110 of the LED bulb.

As noted above, light bulbs typically conform to a standard form factor, which allows bulb interchangeability between different lighting fixtures and appliances. Accordingly, in the present exemplary embodiment, LED bulb 100 includes connector base 115 for connecting the bulb to a lighting fixture. In one example, connector base 115 may be a conventional light bulb base having threads for insertion into a conventional light socket. However, as noted above, it should be appreciated that connector base 115 may be any type of connector for mounting LED bulb 100 or coupling to a power source. For example, connector base may provide mounting via a screw-in base, a dual-prong connector, a standard two- or three-prong wall outlet plug, bayonet base, Edison Screw base, single-pin base, multiple-pin base, recessed base, flanged base, grooved base, side base, or the like.

In some embodiments, LED bulb 100 may use 6 W or more of electrical power to produce light equivalent to a 40 W incandescent bulb. In some embodiments, LED bulb 100 may use 20 W or more to produce light equivalent to or greater than a 100 W incandescent bulb. Depending on the efficiency of the LED bulb 100, between 4 W and 16 W of heat energy may be produced when the LED bulb 100 is illuminated.

The LED bulb 100 includes several components for dissipating the heat generated by LEDs 103. For example, as shown in FIG. 1, LED bulb 100 includes one or more support structures 107 for holding LEDs 103. Support structures 107 may be made of any thermally conductive material, such as aluminum, copper, brass, magnesium, zinc, or the like. In some cases, the support structures are made from a composite laminate material. Since support structures 107 are formed of a thermally conductive material, heat generated by LEDs 103 may be conductively transferred to support structures 107. Thus, support structures 107 may act as a heat-sink or heat-spreader for LEDs 103.

LED support structures 107 may be attached to driver housing 117, which may also be made of any thermally conductive material, such as aluminum, copper, brass, magnesium, zinc, or the like, allowing heat generated by LEDs 103 to be conducted to driver housing 117 through LED support structures 107. In this way, driver housing 117 may also act as a heat-sink or heat-spreader for LEDs 103. LED support structures 107 and driver housing 117 may be formed as one piece or multiple pieces.

Driver housing 117 may enclose a driver circuit configured to provide current to LEDs 103. For an exemplary driver circuit, see U.S. patent application publication no. 2011-0298374 A, which is incorporated herein by reference in its entirety. This or other driver circuits can be used with LED bulb 100 and can be disposed within driver housing 117. Heat generated by the driver circuit may be conducted to driver housing 117 and LED support structures 107. Thus, driver housing 117 and support structures 107 may also act as a heat-sink or heat-spreader for the driver circuit.

Stem body 110 may include one or more components that provide the structural features for mounting bulb shell 101 and driver housing 117. Components of the stem body 110 may include, for example, sealing gaskets, flanges, rings, adaptors, or the like. Stem body 110 may also include a connector base 115 for connecting the bulb to a power source or lighting fixture. Stem body 110 can also include one or more die-cast parts.

LED bulb 100 is filled with thermally conductive liquid 111 for transferring heat generated by LEDs 103 and the driver circuit to shell 101. The thermally conductive liquid 111 fills the enclosed volume defined between shell 101 and stem body 110, allowing the thermally conductive liquid 111 to thermally conduct with both the shell 101 and the components disposed between shell 101 and stem body 110. For example, in some embodiments, thermally conductive liquid 111 is in direct contact with LEDs 103, LED support structures 107, and driver housing 117. By submerging LEDs 103, LED support structures 107, and driver housing 117 (including the driver circuit) in thermally conductive liquid 111, the heat transfer from the LEDs 103 and driver circuit to thermally conductive liquid 111 (and eventually to shell 101 and the air surrounding LED bulb 100) can be increased. As a result, the temperature of LED bulb 100 for a given input power can be lower than more conventional LED bulbs.

Thermally conductive liquid 111 may be any thermally conductive liquid such as mineral oil, silicone oil, glycols (PAGs), fluorocarbons, or other material capable of flowing. It may be desirable to have the liquid chosen be a non-corrosive dielectric.

LED bulb 100 includes a mechanism to allow for thermal expansion of thermally conductive liquid 111 contained in the LED bulb 100. In the present exemplary embodiment, the mechanism is a bladder in fluidic connection with the enclosed volume created between the shell 101 and the stem body 110. The bladder is able to compress and/or expand to compensate for thermal expansion of the thermally conductive liquid. In an alternative configuration, a diaphragm can be used to compensate for thermal expansion of the thermally conductive liquid.

Using a liquid-filled bulb offers several distinct advantages over traditional air-filled bulbs. As discussed above, a bulb filled with a thermally-conductive liquid provides improved heat dissipation from the LEDs, as compared to an air-filled bulb. In addition, because the thermally conductive liquid is disposed between the LED and the shell, the thermally conductive liquid can act as a lens for directing the light emitted by the LEDs.

As discussed above, it may be desirable to produce an LED bulb having a uniform light-distribution profile that conforms with relevant portions of the Energy Star specification directed to LED lamps. Specifically, Section 7A of Energy Star Program states that LED bulbs shall have an even intensity distribution of luminous intensity (candelas) within the 0° to 135° zone (vertically axially symmetrical). Luminous intensity at any angle within this zone shall not differ from the mean luminous intensity for the entire 0° to 135° zone by more than 20%. However, as previously mentioned, not all LED bulb designs inherently produce a light-distribution profile that satisfies these criteria.

The methods discussed below leverage the optical properties of a liquid-filled LED bulb to produce an LED bulb having a uniform light distribution. Specifically, the placement the LEDs within the shell, the shape of the shell, and the geometry of the other components in the LED bulb, alone or in combination, can be selected to produce an LED bulb having a light-distribution profile that satisfies the Energy Star specifications.

In the examples provided below, the LEDs are assumed to have a Lambertian emission profile with a peak light intensity at an angle approximately perpendicular to the face of the LED for the purposes of modeling the distribution of light. Typically, less light is emitted from the LED as the emission angle from the face of the LED is increased.

A liquid-filled shell can be used to increase the uniformity of the light emitted from an LED. In the examples provided below, a shell having an index of refraction of approximately 1.52 for glass is filled with a thermally conductive liquid having an index of refraction of approximately 1.4. If the shell is made from plastic, the index of refraction is approximately 1.58. The shell and the thermally-conductive liquid together act as a lens for diverting light toward portions of the LED bulb where the LED emissions may be weaker.

The shape of the shell, the indices of refraction of the shell and thermally conductive liquid, and the position of the LEDs with respect to the shell, all affect how the light emitted from the LED is diverted. These three parameters can be optimized to produce an LED bulb having a predicted light-distribution profile that satisfies uniformity criteria. In one example, the shell shape is determined by selecting a first radius for the convex portion of the shell and selecting a second radius for the concave portion of the shell. In other examples, the shell may have a variable radius profile shape. An index of refraction is specified for the shell and the thermally conductive liquid to be used to fill the shell. The positions of the LEDs are determined by optimizing the vertical placement of the LEDs with respect to the shell to produce an LED bulb having a predicted light-distribution profile that satisfies uniformity criteria. In another example, the positions of the LEDs and the indices of refraction of the shell and liquid are selected and the shape of the shell is optimized to satisfy light-distribution criteria. In another example, the angles of the LEDs and the number and location of the LEDs are optimized to satisfy light-distribution criteria.

In some cases, a computer model of the optical elements of the LED bulb is created. The computer model can be used to optimize one or more of: the shape of the shell, the indices of refraction of the shell and thermally conductive liquid, the angle of the LEDs and the position of the LEDs with respect to the shell.

2. LED Bulbs with a Clear Shell having a Predicted Light-Distribution Profile

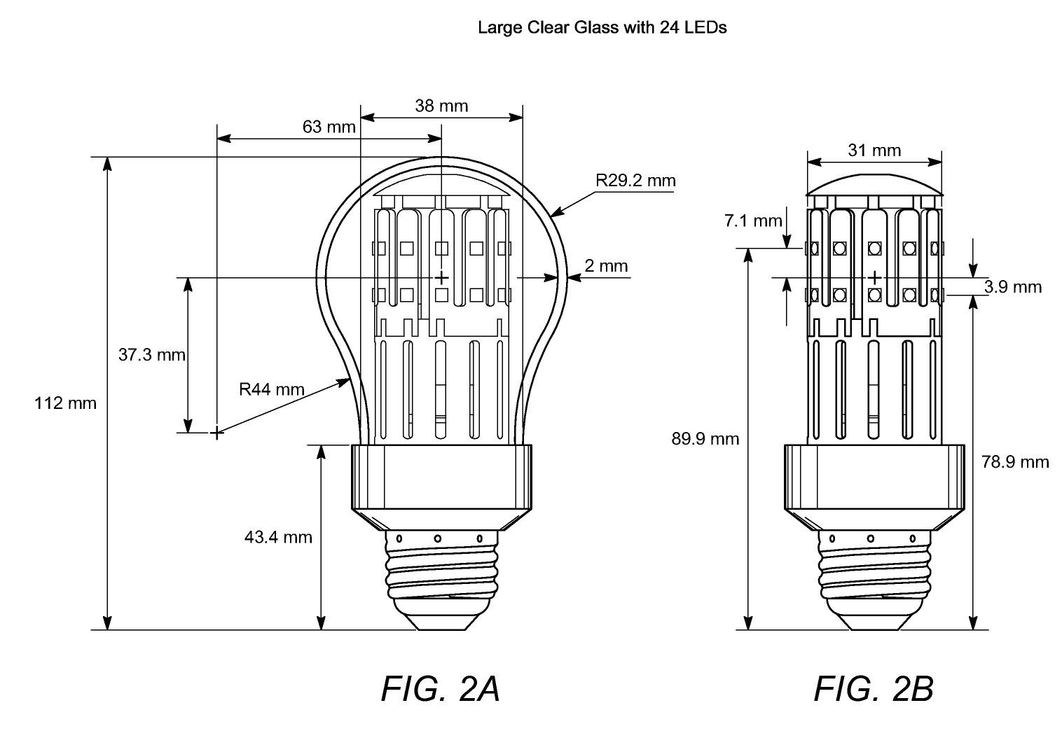

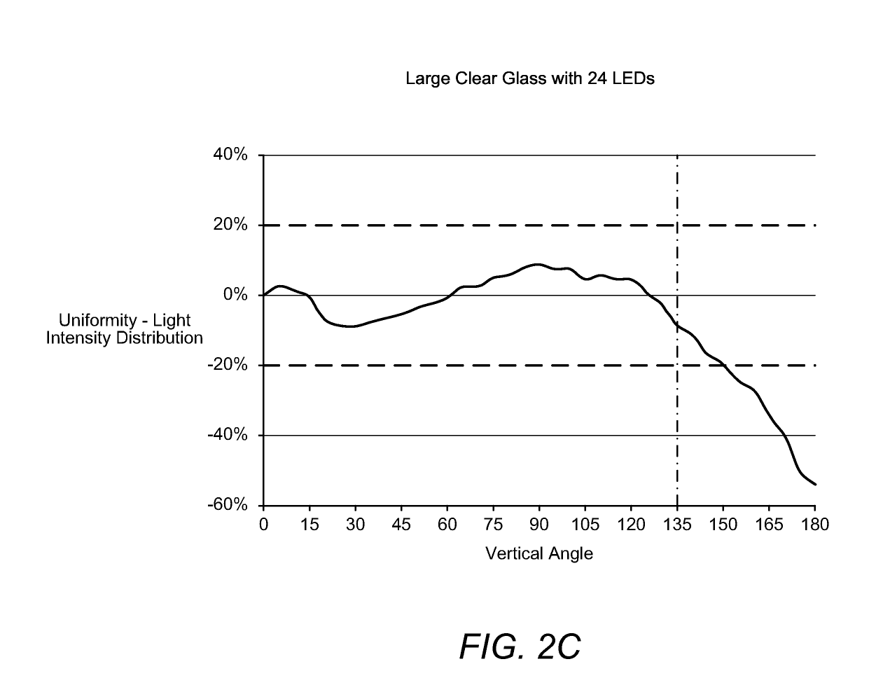

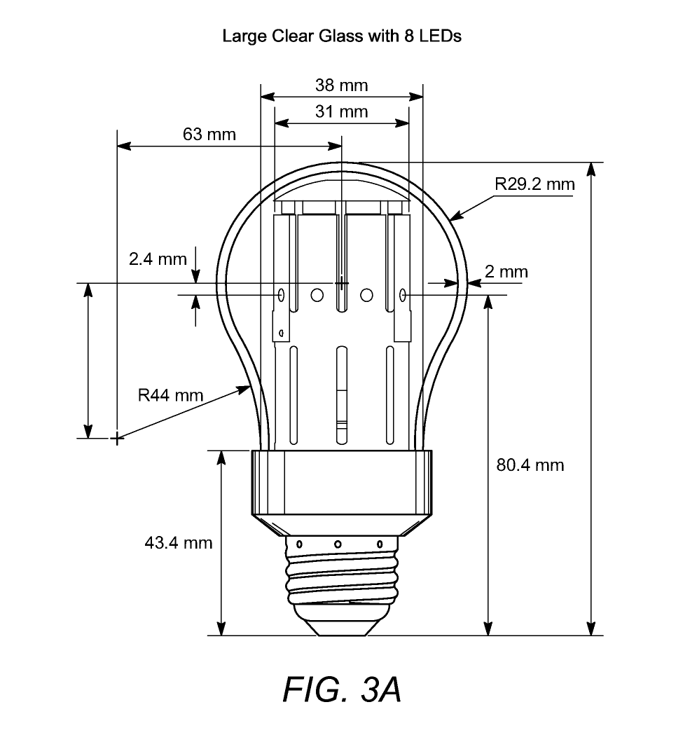

FIGS. 2A-B, 3A, 4A, 5A, and 6A-B depict various embodiments of an LED bulb having a clear shell. Each of these exemplary LED bulbs is filled with a thermally conductive liquid and has a liquid compensation mechanism (e.g., bladder or diaphragm) similar to the LEB bulb 100 described above with respect to FIG. 1.

For the LED bulbs depicted in FIGS. 2A-B, 3A, 4A, 5A, and 6A-B, the position of the LEDs with respect to the shell and the profile shape of the shell are configured to provide the LED bulb with a predicted light-distribution profile that varies less than 20 percent in light intensity over 0 degrees to 135 degrees as measured from an axis from the center of the shell through an apex of the shell. In the examples provided below, the shell has a profile shape with a convex portion and a concave portion, each with a constant radius. In other cases, the shell may have a convex profile shape with a variable radius or another profile shape configured to provide the LED bulb with the desired light-distribution profile.

FIGS. 2A-B depict a liquid-filled bulb having 24 LEDs arranged in a radial pattern. As shown in FIGS. 2A-B, two LEDs are attached to each of 12 support structures (fingers). A first set of LEDs is positioned approximately 7 mm above the center of the convex portion of the shell and a second set of LED is positioned approximately 4 mm below the center of the convex portion of the shell. The LED bulb shown in FIG. 2A has a shell with a convex radius of approximately 29 mm for the convex portion of the shell. The shell also has a concave radius of approximately 44 mm for the concave portion of the shell (near the stem body of the LED bulb). As shown in FIG. 2A, the center of the concave radius is approximately 37.3 mm below the center of the convex radius and approximately 63 mm from the centerline of the bulb.

The predicted light-distribution profile for the LED bulb shown in FIGS. 2A-B is shown in FIG. 2C. The predicted light-distribution profile has a uniformity within +/−9% between 0 degrees and 135 degrees, as measured from an axis through the center of the LED bulb through the apex of the LED bulb (bulb centerline). Thus, the LED bulb shown in FIGS. 2A-B may produce a light-distribution profile that satisfies Energy Star uniformity criteria.

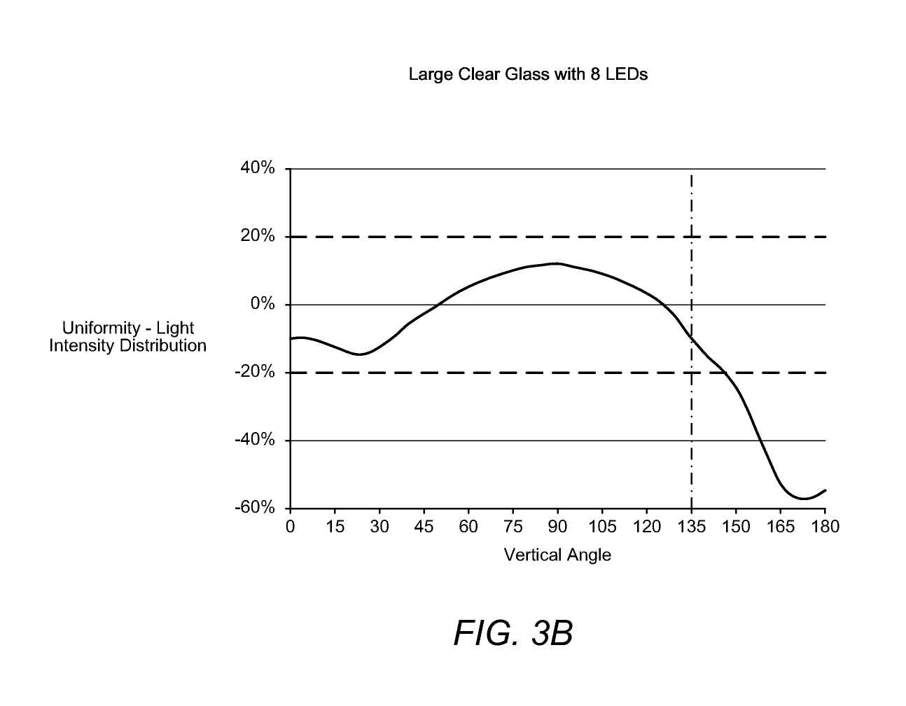

FIG. 3A depicts a liquid-filled bulb having 8 LEDs arranged in a radial pattern. As shown in FIG. 3A, an LED is attached to each of 8 support structures. The LEDs are positioned approximately 2.5 mm below the center of the convex portion of the shell. The LED bulb shown in FIG. 3A has a shell with a convex radius of approximately 29 mm for the convex portion of the shell. The shell also has a concave radius of approximately 44 mm for the lower, concave portion of the shell (near the stem body of the LED bulb). As shown in FIG. 3A, the center of the concave radius is approximately 37.3 mm below the center of the convex radius and approximately 63 mm from the centerline of the bulb.

The predicted light-distribution profile for the LED bulb shown in FIG. 3A is shown in FIG. 3B. The predicted light-distribution profile has a uniformity within +/−14% between 0 degrees and 135 degrees, as measured from an axis through the center of the LED bulb through the apex of the LED bulb. Thus, the LED bulb shown in FIG. 3A may produce a light-distribution profile that satisfies Energy Star uniformity criteria.

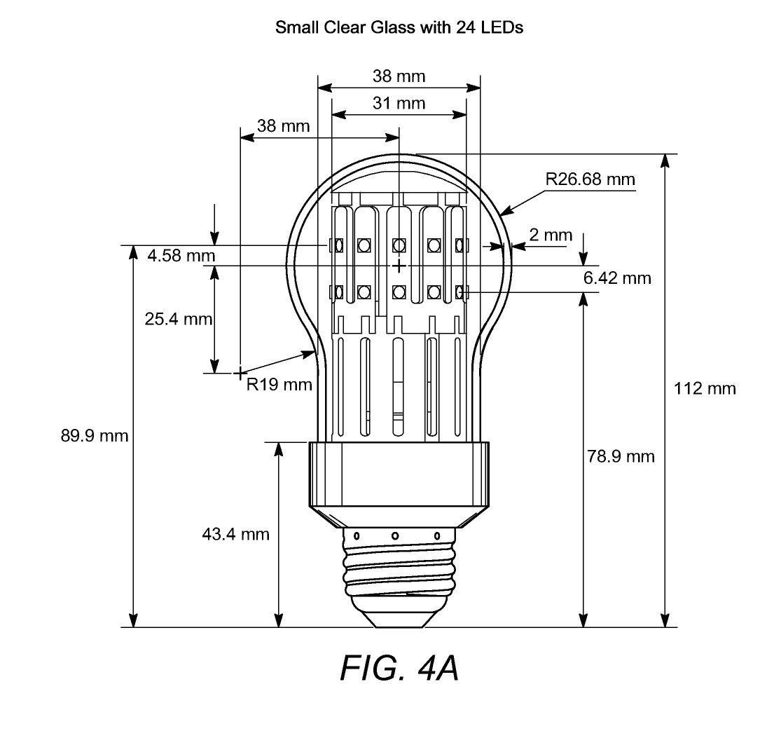

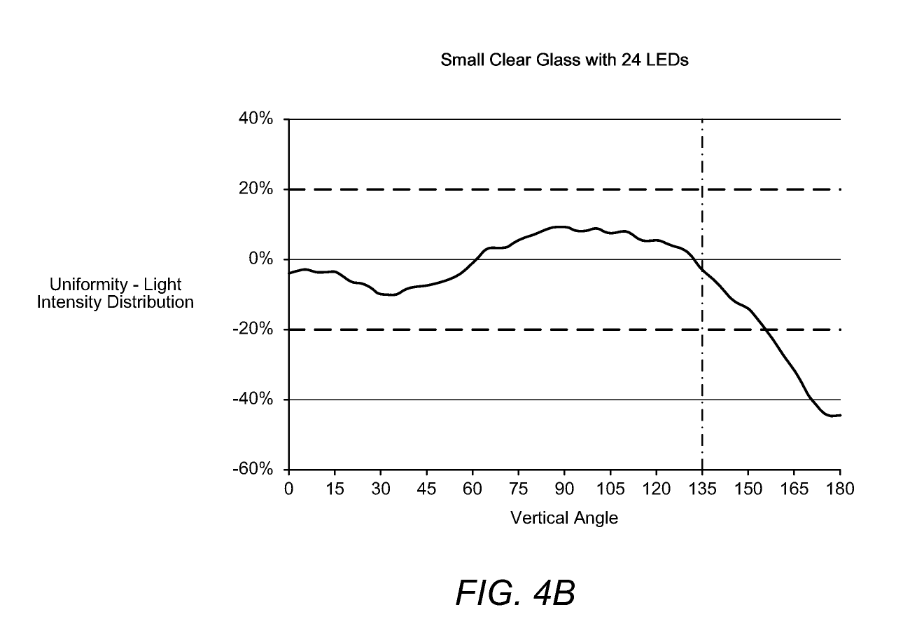

FIG. 4A depicts a liquid-filled bulb having 24 LEDs arranged in a radial pattern. As shown in FIG. 4A, two LEDs are attached to each of 12 support structures. A first set of LEDs is positioned approximately 4.5 mm above the center of the convex portion of the shell and a second set of LEDs is positioned approximately 6.5 mm below the center of the convex portion of the shell. The LED bulb shown in FIG. 4A has a shell with the convex radius of approximately 26.7 mm for the convex portion of the shell. The shell also has a concave radius of approximately 19 mm for the lower, concave portion of the shell (near the stem body of the LED bulb). As shown in FIG. 4A, the center of the concave radius is approximately 25.4 mm below the center of the convex radius and approximately 38 mm from the centerline of the bulb.

The predicted light-distribution profile for the LED bulb shown in FIG. 4A is shown in FIG. 4B. The predicted light-distribution profile has a uniformity within +/−10% between 0 degrees and 135 degrees, as measured from an axis through the center of the LED bulb through the apex of the LED bulb. Thus, the LED bulb shown in FIG. 4A may produce a light-distribution profile that satisfies Energy Star uniformity criteria.

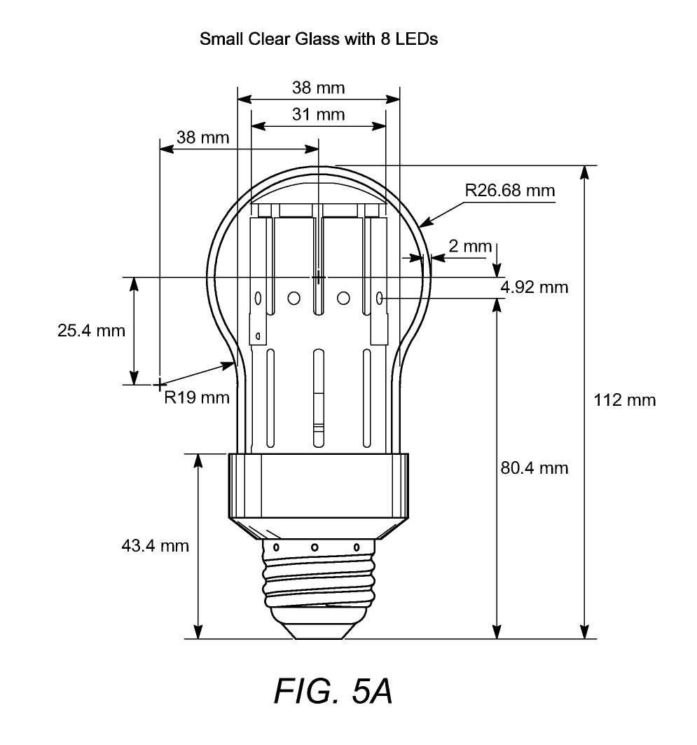

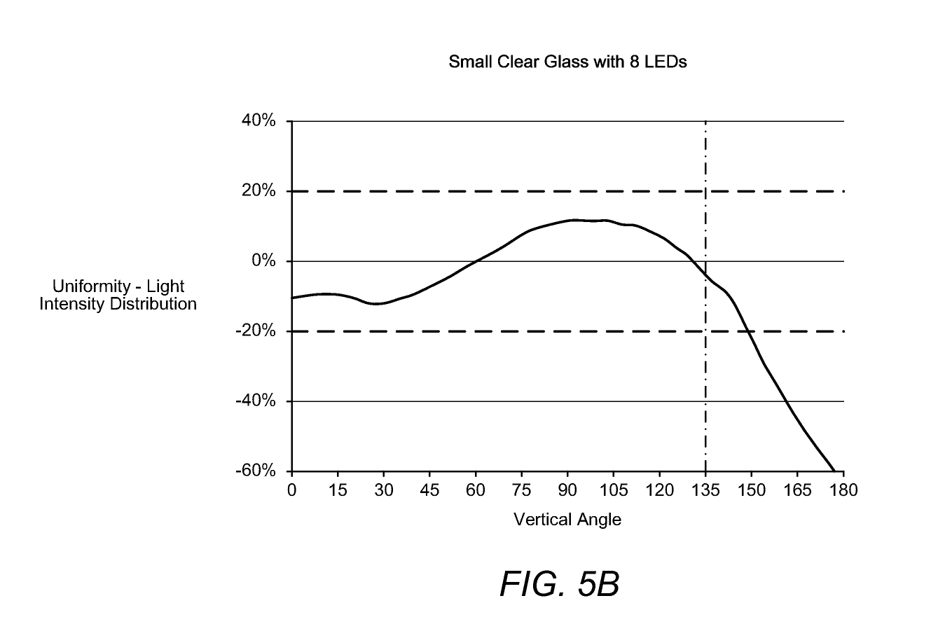

FIG. 5A depicts a liquid-filled bulb having 8 LEDs arranged in a radial pattern. As shown in FIG. 5A, an LED is attached to each of 8 support structures. The LEDs are positioned approximately 5 mm below the center of the convex portion of the shell. The LED bulb shown in FIG. 5A has a shell with a convex radius of approximately 26.7 mm for the convex portion of the shell. The shell also has a concave radius of approximately 19 mm for the lower, concave portion of the shell (near the stem body of the LED bulb). As shown in FIG. 5A, the center of the concave radius is approximately 25.4 mm below the center of the convex radius and approximately 38 mm from the centerline of the bulb.

The predicted light-distribution profile for the LED bulb shown in FIG. 5A is shown in FIG. 5B. The predicted light-distribution profile has a uniformity within +/−12% between 0 degrees and 135 degrees, as measured from an axis through the center of the LED bulb through the apex of the LED bulb. Thus, the LED bulb shown in FIG. 5A may produce a light-distribution profile that satisfies Energy Star uniformity criteria.

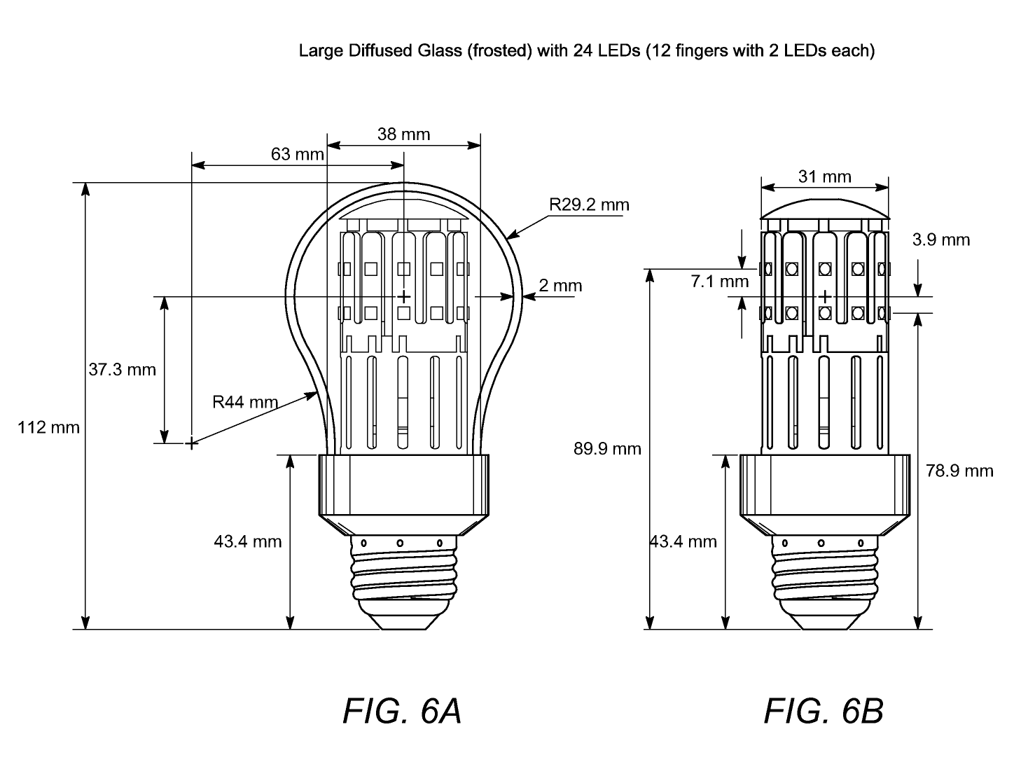

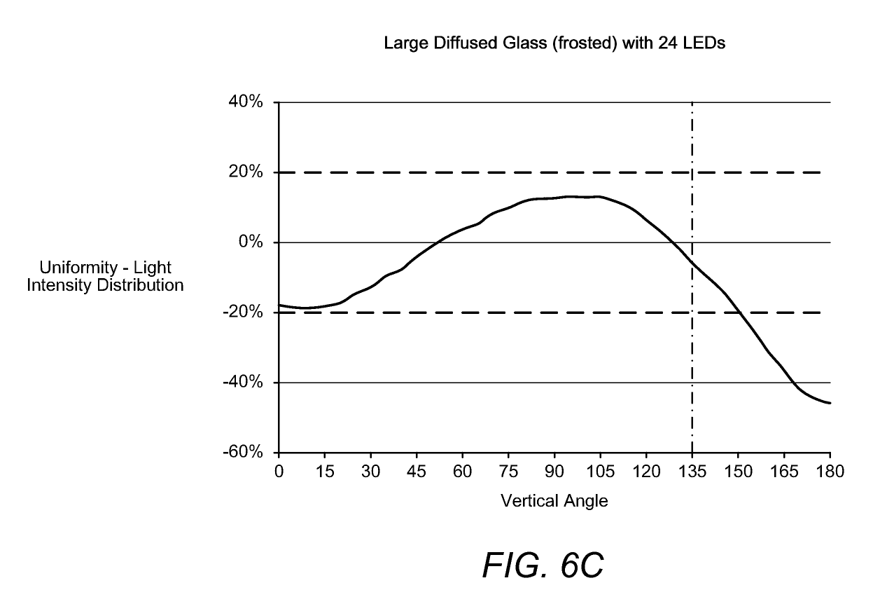

FIGS. 6A-B depict a liquid-filled bulb having a frosted shell and 24 LEDs arranged in a radial pattern. As shown in FIGS. 6A-B, two LEDs are attached to each of 12 support structures (fingers). A first set of LEDs is positioned approximately 7 mm above the center of the convex portion of the shell and a second set of LEDs is positioned approximately 4 mm below the center of the convex portion of the shell. The LED bulb shown in FIG. 6A has a shell with a convex radius of approximately 29 mm for the convex portion of the shell. The shell also has a concave radius of approximately 44 mm for the lower, concave portion of the shell (near the stem body of the LED bulb). As shown in FIG. 6A, the center of the concave radius is approximately 37.3 mm below the center of the convex radius and approximately 63 mm from the centerline of the bulb.

The predicted light-distribution profile for the LED bulb shown in FIGS. 6A-B is shown in FIG. 6C. The predicted light-distribution profile has a uniformity within +13% to −18% between 0 degrees and 135 degrees, as measured from an axis through the center of the LED bulb through the apex of the LED bulb. Thus, the LED bulb shown in FIGS. 6A-B may produce a light-distribution profile that satisfies Energy Star uniformity criteria.

3. LED Bulbs with a Diffuse Shell having a Predicted Light-Distribution Profile

In some embodiments, the shell of the LED bulb may be made from a diffuse material or have a diffuse coating applied to the surface of the shell. In particular, a material or coating may be used that diffuses or scatters light that passes through the shell. In some cases, an LED bulb having a diffuse shell is desirable for aesthetic reasons. For example, a diffuse shell masks the internal components of the LED bulb and gives the LED bulb a more uniform “frosted” appearance.

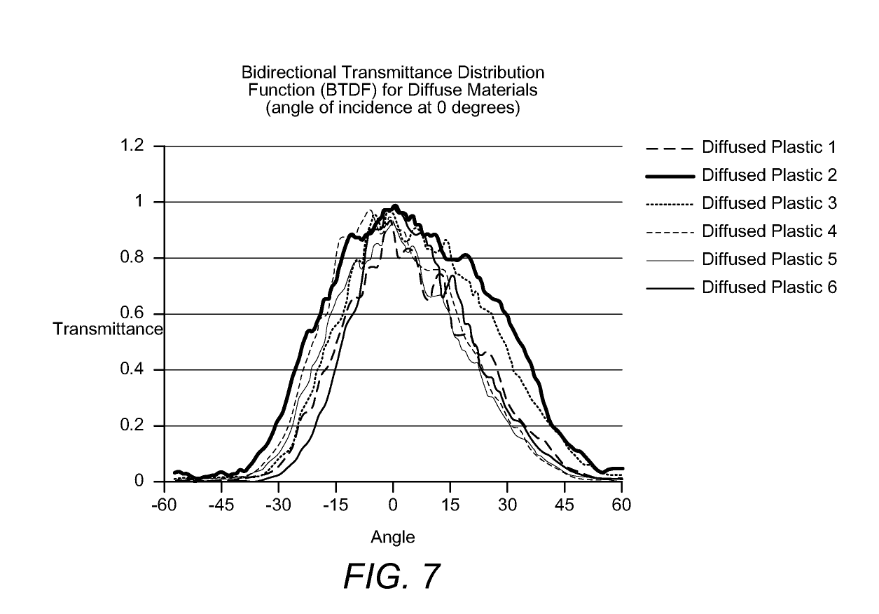

FIG. 7 depicts the light-diffusion profile for an LED bulb with different types of diffusing plastics used for the shell. The bi-directional transmittance distribution function (BTDF) represents the amount of light that is transmitted through the plastic as a function of the angle of transmittance (i.e., the angle at which the transmitted light intensity is measured). For the example depicted in FIG. 7, the source light (a laser) has an angle of incidence of 0 degrees, and the resulting light intensity is measured on the other side of the plastic between 0 degrees and 60 degrees to either side (+/−60 degrees). Typically, the light transmittance is highest at an angle of transmittance of roughly 0 degrees (near the angle of incidence) and drops as the angle is swept through +/−60 degrees. Generally, a more diffuse material will scatter more light further from 0 degrees than a less diffuse material. For purposes of the following discussion, a diffuse shell includes materials having a BTDF that produces more than half of the maximum light intensity at angles greater than 15 degrees from 0 degrees (angle of incidence) and less than 60 degrees from 0 degrees.

Because a diffuse shell changes the path of light emitted by the LEDs, a diffuse shell may create special challenges when designing an LED bulb that satisfies Energy Star uniformity criteria. In general, if the LEDs are oriented perpendicular to the bulb centerline, the majority of the light is emitted in that direction. As a consequence, there is less light directed toward the top of the bulb (0 degrees from bulb centerline) and near the base of the LED bulb (135 degrees from bulb centerline). Using a diffuse shell reduces the amount of light directed toward the top and near the base of the bulb even further. Thus, an LED bulb that satisfies Energy Star uniformity criteria with a clear shell may not satisfy the same criteria with a diffuse shell.

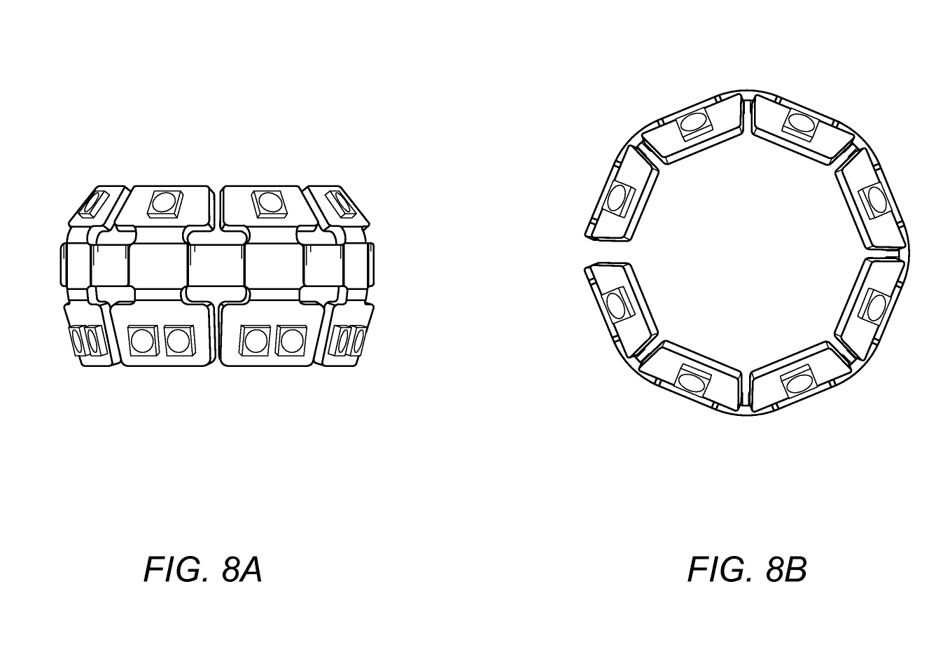

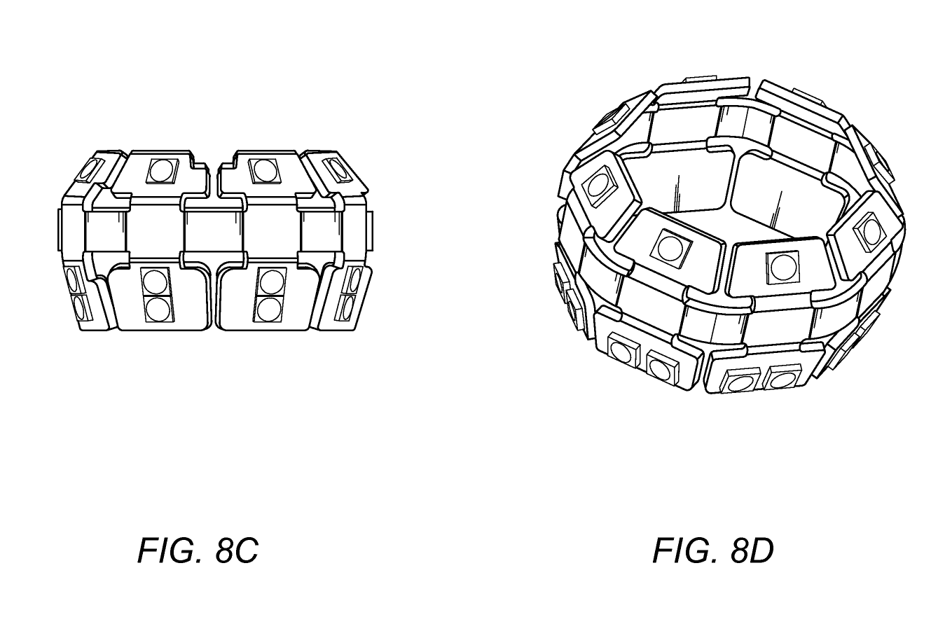

To increase the amount of light that is directed toward the top and near the base of the bulb, the LEDs may be mounted on an angle with respect to the centerline of the bulb. FIGS. 8A-D depict exemplary support structures for mounting the LEDs on an angle with respect to the centerline of the bulb. As shown in FIGS. 8A-D, the LEDs are attached to a radial arrangement of LED support structures in which the top and bottom portion of the fingers are bent inwards, towards the bulb center. FIGS. 8A-D also depict two types of LED arrangements: a first arrangement that includes two lower LEDs aligned horizontally, and a second arrangement that includes two lower LEDs aligned vertically. The LED bulb configurations described below use one of these two arrangements. These two arrangements are exemplary in nature—other arrangements of the LEDs mounted on an angle may also be used.

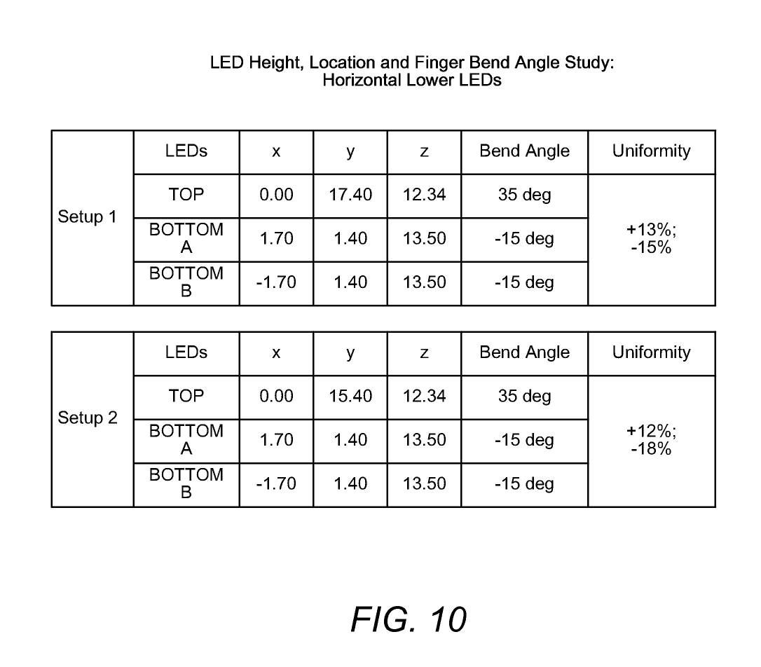

For many of the LED bulb configurations depicted in FIGS. 10, 11, 12A-B, and 13, the position of the LEDs with respect to the shell, the angle of the LEDs, and the profile shape of the shell are configured to provide the LED bulb with a predicted light-distribution profile that varies less than 20 percent in light intensity over 0 degrees to 135 degrees as measured from an axis from the center of the shell through an apex of the shell. In the examples provided below, the shell has a profile shape with a convex portion and a concave portion, each with a constant radius. In other cases, the shell may have a convex profile shape with a variable radius or another profile shape configured to provide the LED bulb with the desired light-distribution profile.

As shown in FIG. 10, an angle for a set of top LEDs and an angle for a set of bottom LEDs can be selected to produce a light-distribution profile that satisfies relevant portions of the Energy Star uniformity criteria. FIG. 10 depicts the results of two exemplary simulations evaluating the effect of LED height, location, and LED angle on light uniformity. For the simulations performed in FIG. 10, the top portion of each finger is angled inwards (towards the center of the bulb) at 35 degrees with respect to the bulb centerline, and the bottom portion is angled at −15 degrees. Each finger has one LED on the top portion of the finger and two LEDs on the bottom portion of the finger. The two LEDs on the bottom portion are aligned horizontally.

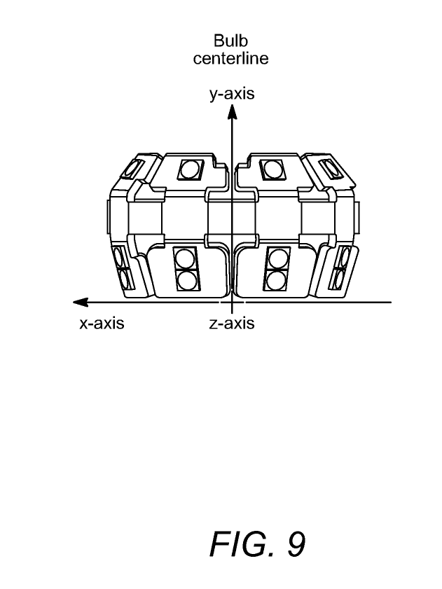

The x, y, and z LED locations shown in the table are in millimeters with respect to the center of the convex portion of the shell, as indicated by the axes in FIG. 9. FIG. 9 depicts an exemplary support structure and a coordinate system origin. As shown in FIG. 9, the y-axis is aligned with the LED bulb centerline and the x- and z-axes pass through the center of the convex portion of the shell.

As shown in FIG. 10, both Setup 1 and Setup 2 represent configurations that can be used to produce an LED bulb that satisfies the Energy Star uniformity criteria of +/−20%. In particular, for the configurations depicted in FIG. 9, the y-position of the top set of LEDs may vary between 15.4 and 17.4 mm and still satisfy Energy Star uniformity criteria.

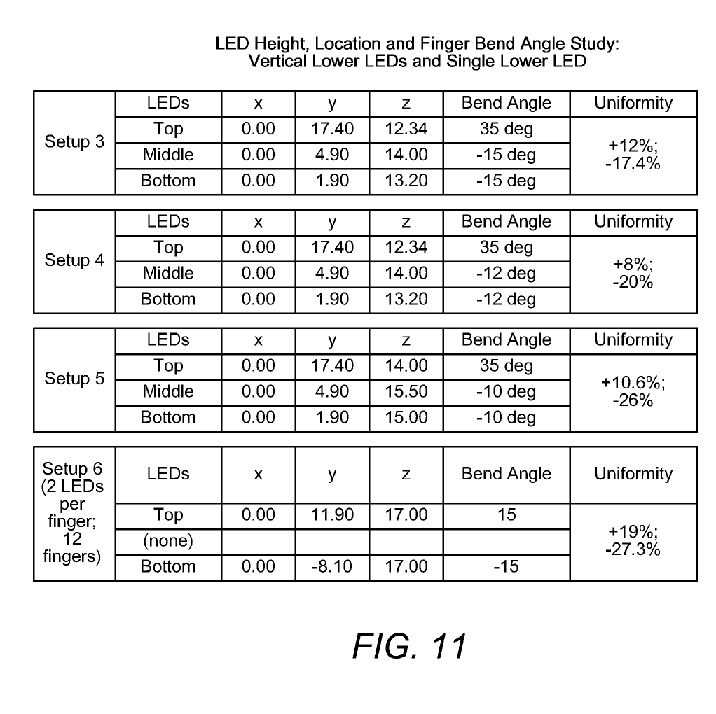

FIG. 11 depicts simulation results for alternative configurations showing the effect of LED location and angle on light uniformity. In FIG. 11, the top portion of the finger is angled inwards at either 35 degrees (Setups 3-5) or 15 degrees (Setup 6), while the bottom portion is angled at −10, −12, or −15 degrees. The x, y, and z LED locations shown in the table are in millimeters with respect to the center of the convex portion of the shell, as indicated by the axes in FIG. 9. In Setups 3-5, each finger has one LED on the top portion of the finger and two LEDs on the bottom portion of the finger, aligned vertically. In Setup 6, the lower portion of the finger has only one LED. As shown in FIG. 10, the configurations for Setup 3 and 4 may be used to produce an LED bulb that satisfies a uniformity criteria of +/−20%.

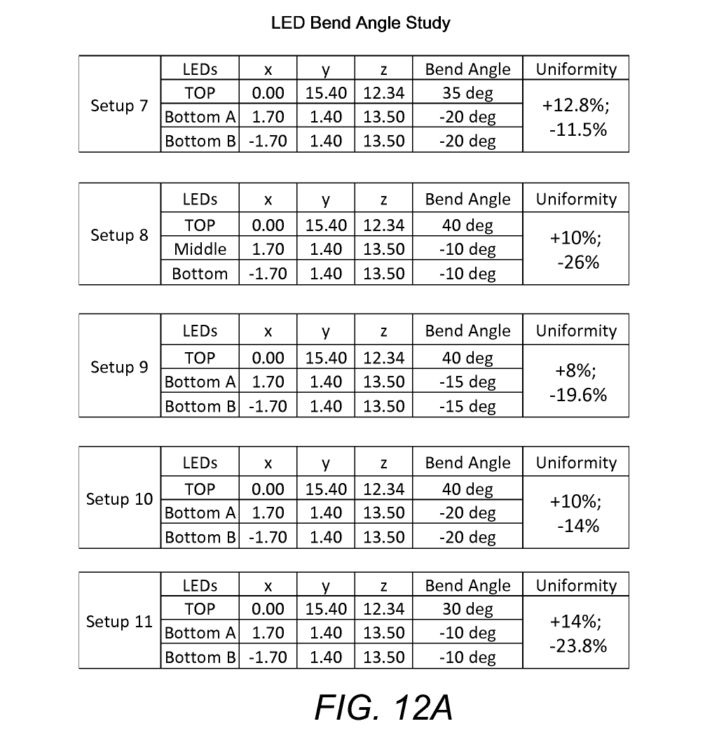

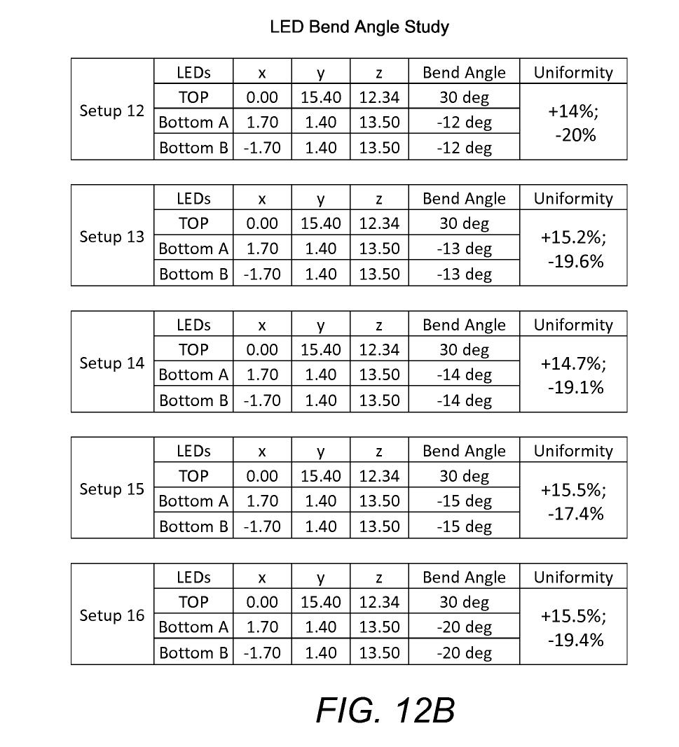

FIGS. 12A-B depict simulation results for alternative configurations showing the effect of the finger bend angle on light uniformity. As shown in FIGS. 12A-B, Setups 7-10 and 12-16 represent configurations that can be used to produce an LED bulb that satisfies the Energy Star uniformity criteria of +/−20%. The x, y, and z LED locations shown in the table are in millimeters with respect to the center of the convex portion of the shell, as indicated by the axes in FIG. 9. For the configurations depicted in FIGS. 12A-B, the top bend angle may vary between 30-40 degrees, and the bottom bend angle may vary between −10 and −20 degrees and still satisfy Energy Star uniformity criteria for certain combinations of top and bottom bend angles.

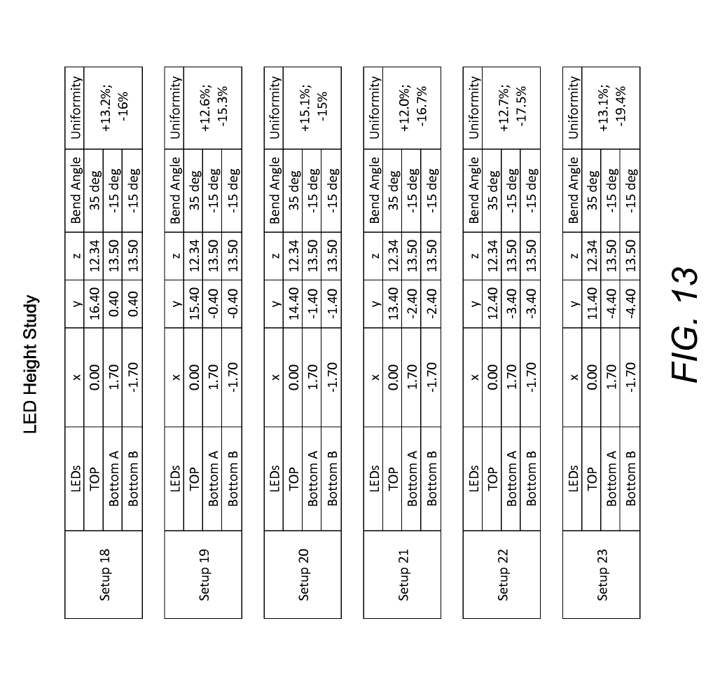

FIG. 13 depicts simulation results for alternative configurations showing the effect of LED height (on the y-axis) on light uniformity. As shown in FIG. 13, Setups 18-23 represent configurations that can be used to produce an LED bulb that satisfies the Energy Star uniformity criteria of +/−20%. The x, y, and z LED locations shown in the table are in millimeters with respect to the center of the convex portion of the shell, as indicated by the axes in FIG. 9. In the bulb configurations of FIG. 12, the LED on the top of the finger is placed at heights varying from approximately 11.5 mm to 16.5 mm above the center of the convex portion of the shell, while the two horizontal LEDs on the bottom of the finger are placed at heights ranging from approximately 0.5 mm above the center of the convex portion of the shell to approximately 4.5 mm below the center of the convex portion of the shell.

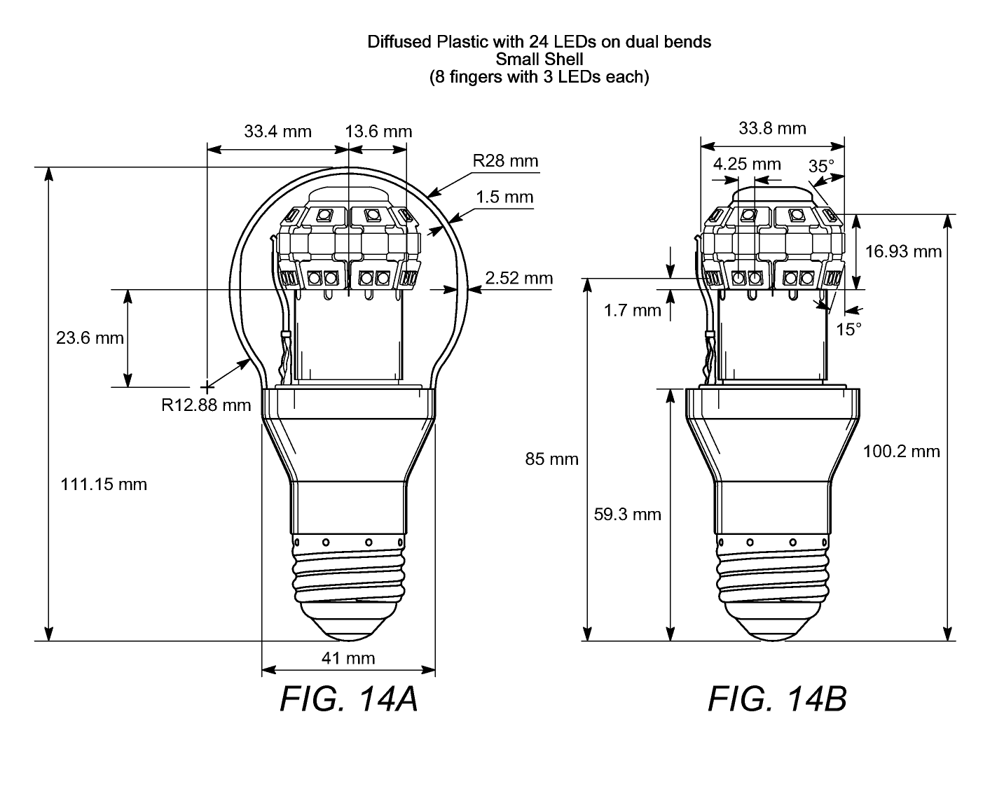

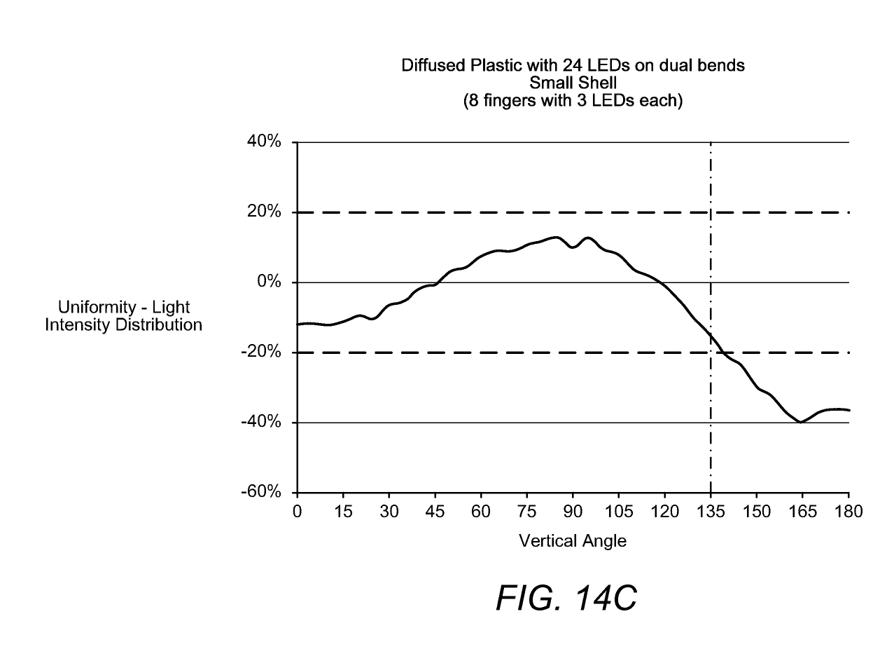

For the LED bulbs depicted in FIGS. 14A-B, 15A, and 16A-B, the position of the LEDs with respect to the shell, the angle of the LEDs, and the profile shape of the shell are configured to provide the LED bulb with a predicted light-distribution profile that varies less than 20 percent in light intensity over 0 degrees to 135 degrees as measured from an axis from the center of the shell through an apex of the shell.

FIGS. 14A-B depict a liquid-filled LED bulb having a diffused plastic shell and 24 LEDs arranged in a radial pattern along eight fingers of a support structure. As shown in FIGS. 8A-D, the fingers are bent at the top and at the bottom to provide an upper surface that is angled upward and a lower surface that is angled downwards. As shown in FIG. 14B, the upper portion of each finger is bent at an angle of 35 degrees with respect to the bulb centerline and the lower surface is bent at an angle of −15 degrees with respect to the bulb centerline. A first set of 8 LEDs is positioned on the top portion of the fingers (one LED per finger). A second set of 16 LEDs is positioned on the bottom portion of the fingers (two LEDs per finger, aligned horizontally). The two LEDs on the bottom portion of each finger are spaced approximately 4.25 mm apart center-to-center, and approximately 1 mm apart edge-to-edge. A first set of LEDs is positioned approximately 17 mm above the center of a convex portion of the shell and a second set of LED is positioned approximately 2 mm above the center of the convex portion of the shell. The LED bulb shown in FIG. 14A includes a shell having a convex radius of approximately 28 mm for the upper, convex portion of the shell. The shell also has a concave radius of approximately 13 mm for the lower, concave portion of the shell (near the stem body of the LED bulb). As shown in FIG. 13A, the center of the concave radius is approximately 23.5 mm below the center of the convex radius and approximately 33.5 mm from the centerline of the bulb.

FIG. 14C depicts the predicted light-distribution profile for the LED bulb depicted in FIGS. 14A-B. The predicted light-distribution profile has a uniformity within +13% to −15% between 0 degrees and 135 degrees, as measured from an axis through the center of the LED bulb through the apex of the LED bulb. Thus, the LED bulb shown in FIGS. 13A-B may produce a light-distribution profile that satisfies Energy Star uniformity criteria.

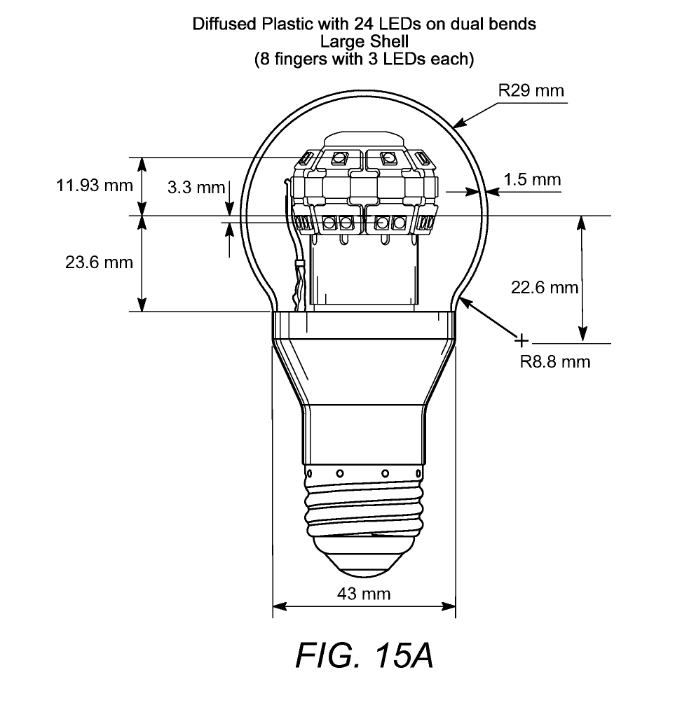

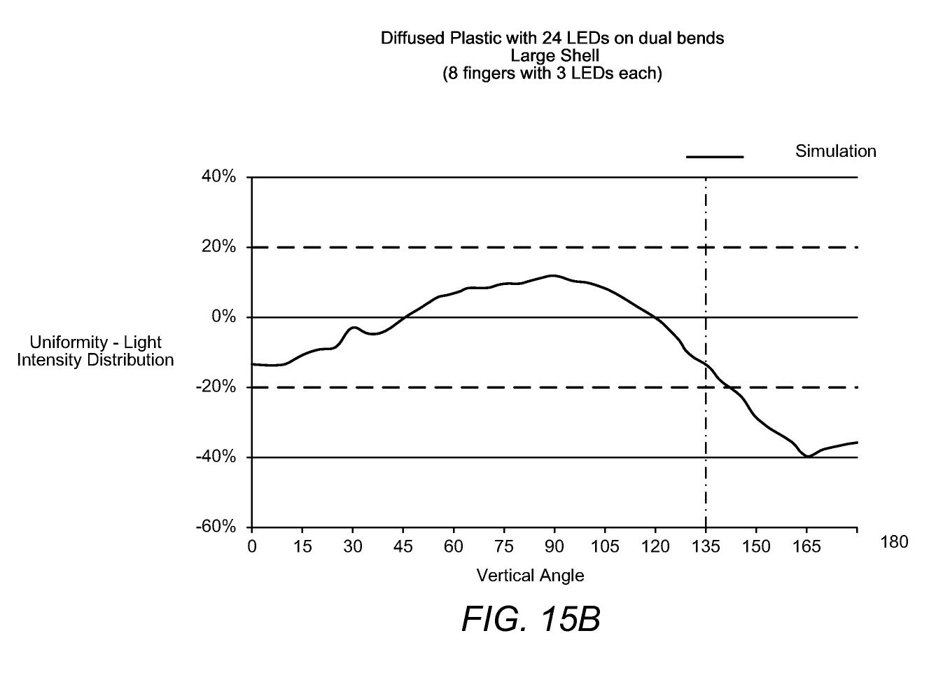

FIG. 15A depicts a liquid-filled LED bulb having a larger diffused plastic shell (relative to the bulb shown in FIGS. 14A-B) and 24 LEDs arranged in a radial pattern along eight fingers of a support structure. As shown in FIGS. 8A-D, the fingers are bent at the top and at the bottom to provide an upper surface that is angled upward and a lower surface that is angled downwards. The upper portion of each finger is bent at an angle of 35 degrees with respect to the bulb centerline and the lower surface is bent at an angle of −15 degrees with respect to the bulb centerline. A first set of 8 LEDs is positioned on the top portion of the fingers (one LED per finger). A second set of 16 LEDs is positioned on the bottom portion of the fingers (two LEDs per finger, aligned horizontally). The two LEDs on the bottom portion of each finger are spaced approximately 4.25 mm apart center-to-center, and approximately 1 mm apart edge-to-edge. A first set of LEDs is positioned approximately 12 mm above the center of a convex portion of the shell and a second set of LEDs is positioned approximately 3.5 mm below the center of the convex portion of the shell. The LED bulb shown in FIG. 15A includes a shell having a convex radius of approximately 29 mm for the upper, convex portion of the shell. The shell also has a concave radius of approximately 9 mm for the lower, concave portion of the shell (near the stem body of the LED bulb). As shown in FIG. 15A, the center of the concave radius is approximately 22.5 mm below the center of the convex radius.

FIG. 15B depicts the predicted light-distribution profile for the LED bulb depicted in FIG. 15A. The predicted light-distribution profile has a uniformity within +12% to −14% between 0 degrees and 135 degrees, as measured from an axis through the center of the LED bulb through the apex of the LED bulb. Thus, the LED bulb shown in FIG. 14A may produce a light-distribution profile that satisfies Energy Star uniformity criteria.

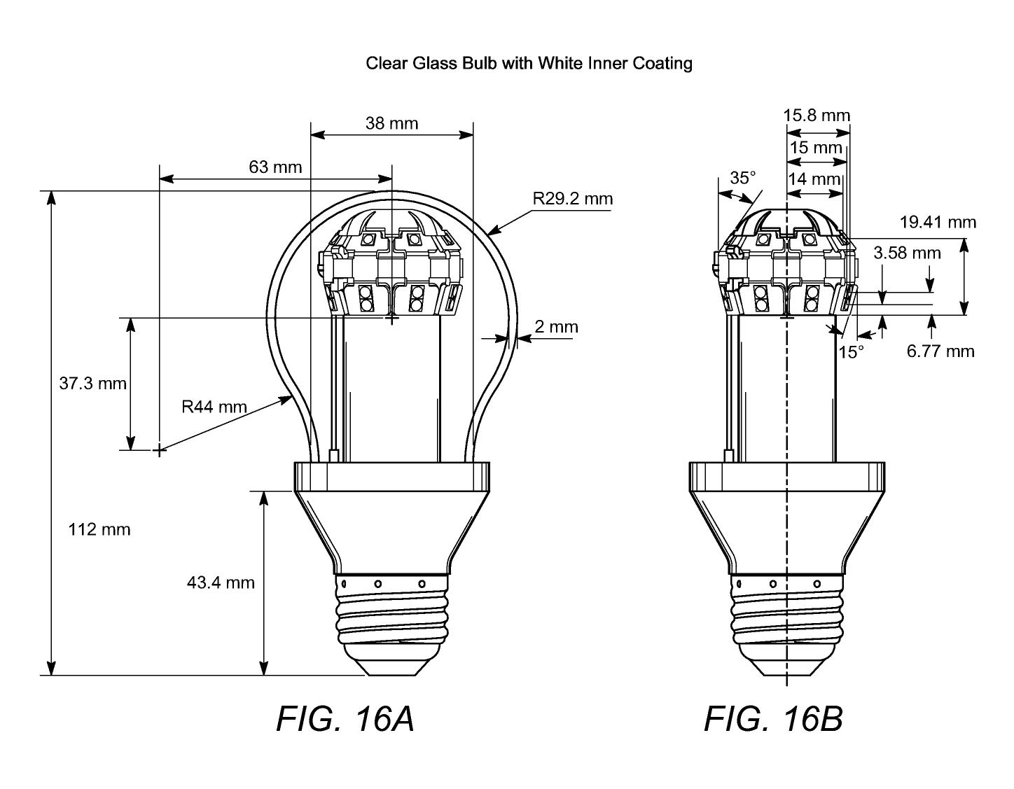

FIGS. 16A-B depict a liquid-filled LED bulb having a clear glass shell with a white diffuse coating. The bulb of FIGS. 16A-B has 24 LEDs arranged in a radial pattern along eight fingers. The fingers have been bent at the top and at the bottom, with the upper portion bent at an angle of 35 degrees from the vertical and the lower portion bent at an angle of −15 degrees. A first set of 8 LEDs is positioned on the top portion of the fingers (one LED per finger). A second set of 16 LEDS is positioned on the bottom portion of the fingers (two LEDs per finger, aligned vertically). The bottom LED is spaced approximately 3.5 mm above the center of the convex portion of the shell and the middle LED is spaced approximately 7 mm above the center of the convex portion of the shell. The LED on the top portion of each finger is spaced approximately 19.5 mm above the center of the convex portion of the shell.

The LED bulb shown in FIG. 16A has a shell with a radius of approximately 29 mm for the upper, convex portion of the shell. The shell also has a radius of approximately 44 mm for the lower, concave portion of the shell (near the stem body of the LED bulb). As shown in FIG. 16A, the center of the concave radius is approximately 37 mm below the center of the convex radius and approximately 63 mm from the centerline of the bulb.

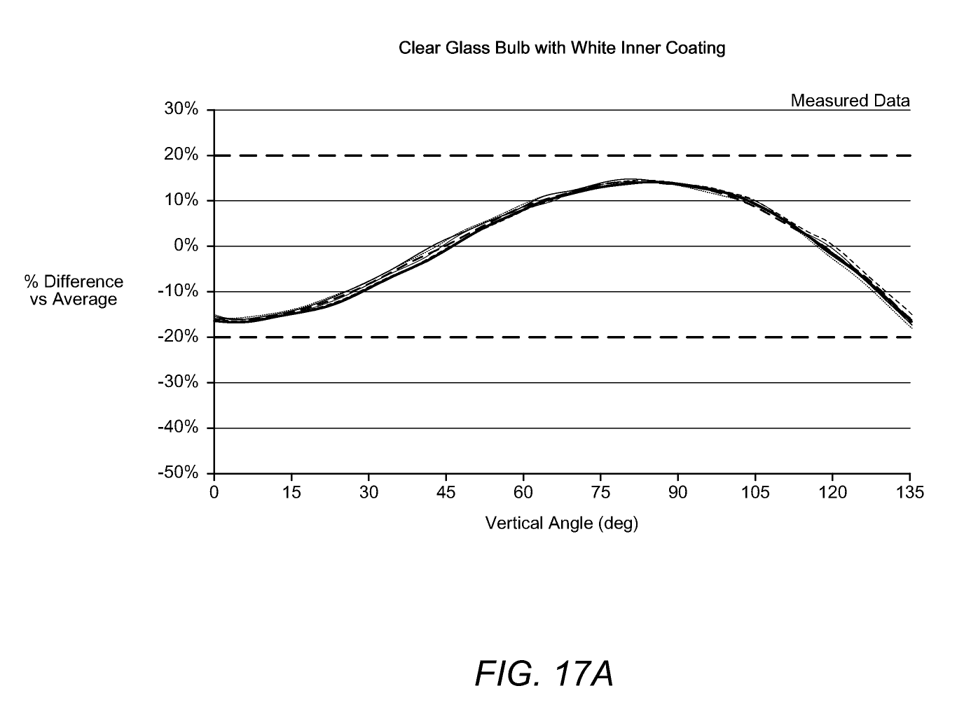

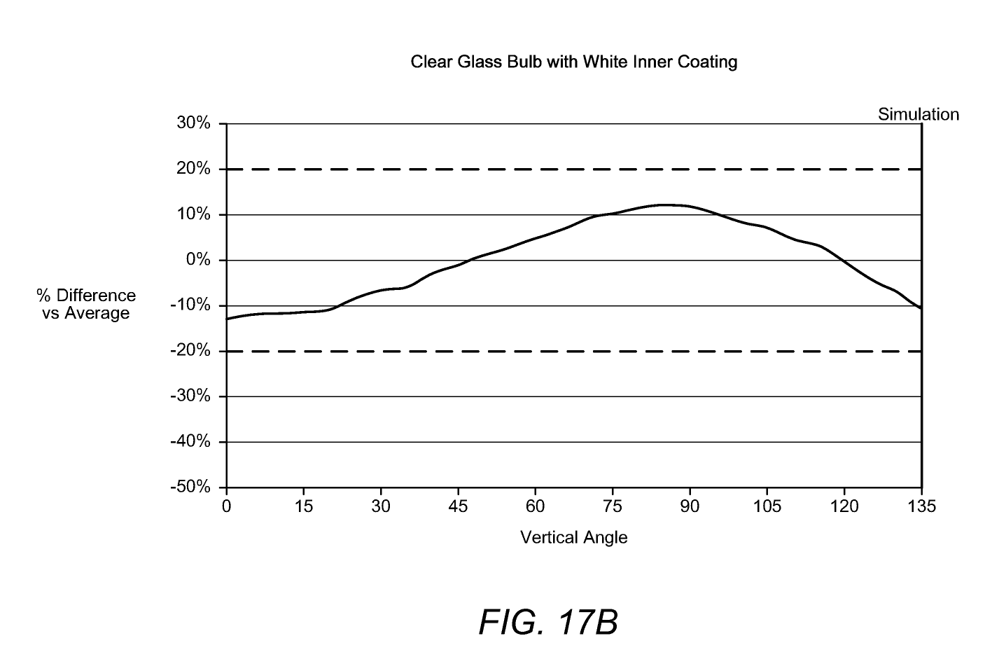

FIG. 17B depicts the predicted light-distribution profile for the LED bulb depicted in FIGS. 16A-B. The predicted light-distribution profile has a uniformity within +12% to −13% between 0 degrees and 135 degrees, as measured from an axis through the center of the LED bulb through the apex of the LED bulb. Thus, the LED bulb shown in FIGS. 16A-B may produce a light-distribution profile that satisfies Energy Star uniformity criteria.

FIGS. 17A-B depict the measured light-distribution profile of an actual bulb as compared the light-distribution profile of a simulated LED bulb having the same configuration. The configuration of these bulbs is described above with respect to FIGS. 16A-B As shown in FIGS. 17A-B, the measured light distribution of the actual LED bulb corresponds to the light distribution predicted by the simulation. The measured data shows a light-distribution uniformity of +14% to −17%, while the simulated values are +12% to −13%.

Although a feature may appear to be described in connection with a particular embodiment, one skilled in the art would recognize that various features of the described embodiments may be combined. Moreover, aspects described in connection with an embodiment may stand alone.

We claim:

1. A liquid-filled light-emitting diode (LED) bulb comprising:
a stem body;
a shell connected to the stem body;
a plurality of LEDs disposed within the shell; and
a thermally conductive liquid held within the shell and disposed between the plurality of LEDs and the shell, wherein:
a first set of LEDs of the plurality of LEDs is positioned a first distance with respect to the center of a convex portion of the shell,
a second set of LEDs of the plurality of LEDs is positioned a second distance with respect to the center of the convex portion of the shell,
the shell has a convex radius for the convex portion and a concave radius for a convex portion, and
the first and second sets of LEDs and the shell are configured to provide the LED bulb with a predicted light-distribution profile that varies less than 20 percent in light intensity over 0 degrees to 135 degrees as measured from an axis from the center of the shell through an apex of the shell.

2. The LED bulb of claim 1, wherein the first set of LEDs of the plurality of LEDs is positioned above the center of the convex portion of the shell, and the second set of LEDs of the plurality of LEDs is positioned below the center of the convex portion of the shell.

3. The LED bulb of claim 1, wherein the first distance ranges from 4.5 mm to 7 mm and the second distance ranges from 4 mm to 6.5 mm.

4. The LED bulb of claim 1, wherein the convex radius ranges from 26.5 mm to 29 mm and the concave radius ranges from 19 mm to 44 mm.

5. The LED bulb of claim 1, wherein the plurality of LEDs are positioned in a radial array around the axis from the center of the shell through an apex of the shell, the radial array having a diameter of approximately 31 mm.

6. A liquid-filled light-emitting diode (LED) bulb comprising:
a stem body;
a shell connected to the stem body;
a plurality of LEDs disposed within the shell; and
a thermally conductive liquid held within the shell and disposed between the plurality of LEDs and the shell, wherein:
a first set of LEDs of the plurality of LEDs is positioned a first distance with respect to the center of a convex portion of the shell,
a second set of LEDs of the plurality of LEDs is positioned a second distance with respect to the center of the convex portion of the shell, and
the first and second sets of LEDs and the shell are configured to provide the LED bulb with a predicted light-distribution profile that varies less than 20 percent in light intensity over 0 degrees to 135 degrees as measured from an axis from the center of the shell through an apex of the shell.

7. The LED bulb of claim 6, wherein the position of the first and second sets of LEDs with respect to the shell and the profile shape of the shell are configured to provide the LED bulb with the predicted light-distribution profile.

8. A liquid-filled light-emitting diode (LED) bulb comprising:
a stem body;
a shell connected to the stem body;
a plurality of LEDs disposed within the shell; and
a thermally conductive liquid held within the shell and disposed between the plurality of LEDs and the shell, wherein:
the plurality of LEDs is positioned a first distance with respect to the center of a convex portion of the shell,
the shell has a convex radius for the convex portion and a concave radius for a convex portion, and
the plurality of LEDs and the shell are configured to provide the LED bulb with a predicted light-distribution profile that varies less than 20 percent in light intensity over 0 degrees to 135 degrees as measured from an axis from the center of the shell through an apex of the shell.

9. The LED bulb of claim 8, wherein the plurality of LEDs is positioned below the center of the convex portion of the shell.

10. The LED bulb of claim 8, wherein the first distance ranges from 2.5 mm to 5 mm.

11. The LED bulb of claim 8, wherein the convex radius ranges from 26.5 mm to 29 mm and the concave radius ranges from 19 mm to 44 mm.

12. The LED bulb of claim 8, wherein the plurality of LEDs are positioned in a radial array around the axis from the center of the shell through an apex of the shell, the radial array having a diameter of approximately 31 mm.

13. A liquid-filled light-emitting diode (LED) bulb comprising:
a stem body;
a shell connected to the stem body;
a plurality of LEDs disposed within the shell; and
a thermally conductive liquid held within the shell and disposed between the plurality of LEDs and the shell, wherein:
the plurality of LEDs is positioned a first distance with respect to the center of a convex portion of the shell,
the plurality of LEDs and the shell are configured to provide the LED bulb with a predicted light-distribution profile that varies less than 20 percent in light intensity over 0 degrees to 135 degrees as measured from an axis from the center of the shell through an apex of the shell.

14. The LED bulb of claim 13, wherein the position of the plurality of LEDs with respect to the shell and the profile shape of the shell are configured to provide the LED bulb with the predicted light-distribution profile.

15. A liquid-filled light-emitting diode (LED) bulb comprising:
a stem body;
a shell connected to the stem body;
a plurality of LEDs disposed within the shell; and
a thermally conductive liquid held within the shell and disposed between the plurality of LEDs and the shell, wherein:
a first set of LEDs of the plurality of LEDs is positioned a first distance with respect to the center of a convex portion of the shell, and at a first angle with respect to a centerline of the LED bulb,
a second set of LEDs of the plurality of LEDs is positioned a second distance with respect to the center of the convex portion of the shell, and at a second angle with respect to the centerline of the LED bulb,
the shell has a convex radius for the convex portion and a concave radius for a convex portion, and
the first and second sets of LEDs and the shell are configured to provide the LED bulb with a predicted light-distribution profile that varies less than 20 percent in light intensity over 0 degrees to 135 degrees as measured from an axis from the center of the shell through an apex of the shell.

16. The LED bulb of claim 15, wherein the shell is made from a diffuse material that is configured to scatter light emitted by the plurality of LEDs.

17. The LED bulb of claim 16, wherein the diffuse material has a bidirectional transmittance distribution function (BTDF) that, for light that is perpendicularly incident to the surface, results more than half of the maximum light intensity at angles greater than 15 degrees from the angle of incidence and less than 60 degrees from the angle of incidence.

18. The LED bulb of claim 15, wherein the shell includes a diffuse coating that is configured to scatter light emitted by the plurality of LEDs.

19. The LED bulb of claim 15, wherein the first set of LEDs of the plurality of LEDs is positioned above the center of the convex portion of the shell, and the second set of LEDs of the plurality of LEDs is positioned above the center of the convex portion of the shell.

20. The LED bulb of claim 15, wherein the first angle is between 30 and 40 degrees from the centerline of the LED bulb and the second angle is between −10 and −20 degrees from the centerline of the LED bulb.

21. The LED bulb of claim 15, wherein the first distance ranges from 17.5 mm to 11.5 mm above the center of the convex portion of the shell, and the second distance ranges from 0.5 mm above the center of the convex portion of the shell and 4.5 below the center of the convex portion of the shell.

22. The LED bulb of claim 15, wherein the second set of LEDs of the plurality of LEDs includes multiple pairs of LEDs that are horizontally aligned.

23. The LED bulb of claim 15, wherein the second set of LEDs of the plurality of LEDs includes multiple pairs of LEDs that are vertically aligned.

24. A liquid-filled light-emitting diode (LED) bulb comprising:
a stem body;
a shell connected to the stem body;
a plurality of LEDs disposed within the shell; and
a thermally conductive liquid held within the shell and disposed between the plurality of LEDs and the shell, wherein:
a first set of LEDs of the plurality of LEDs is positioned a first distance with respect to the center of a convex portion of the shell, and at a first angle with respect to a centerline of the LED bulb,
a second set of LEDs of the plurality of LEDs is positioned a second distance with respect to the center of the convex portion of the shell, and at a second angle with respect to the centerline of the LED bulb, and
the first and second sets of LEDs and the shell are configured to provide the LED bulb with a predicted light-distribution profile that varies less than 20 percent in light intensity over 0 degrees to 135 degrees as measured from an axis from the center of the shell through an apex of the shell.

25. The LED bulb of claim 24, wherein the position of the first and second sets of LEDs with respect to the shell, the angle he first and second sets of LEDs with respect to the shell, and the profile shape of the shell are configured to provide the LED bulb with the predicted light-distribution profile.

26. A method of making an LED bulb, the method comprising:
obtaining a stem body;
connecting a shell to the stem body;
placing a plurality of LEDs within the shell; and
filling the shell with a thermally conductive liquid, wherein:
a first set of LEDs of the plurality of LEDs is positioned a first distance with respect to the center of a convex portion of the shell, and at a first angle with respect to a centerline of the LED bulb,
a second set of LEDs of the plurality of LEDs is positioned a second distance with respect to the center of the convex portion of the shell, and at a second angle with respect to the centerline of the LED bulb,
the first and second sets of LEDs and the shell are configured to provide the LED bulb with a predicted light-distribution profile that varies less than 20 percent in light intensity over 0 degrees to 135 degrees as measured from an axis from the center of the shell through an apex of the shell.
